(19) United States
(12) Patent Application Publication
(10) Pub. No.: US 2007/0071899 A1
(43) Pub. Date: Mar. 29, 2007

(54) Method for increasing moisture content in extrusion coated paperboard

(76) Inventors: Mark Olin Mason, Covington, VA (US); Barry Gene Calvert, Covington, VA (US); Richard E. Nordgren, Daleville, VA (US)

Correspondence Address: THOMPSON HINE L.L.P., P.O. BOX 8801, DAYTON, OH, 45401-8801, US

(21) Appl. No.: 11/522,741

(22) Filed: Sep. 18, 2006

Related U.S. Application Data
(62) Division of application No. 10/899,650, filed on Jul. 27, 2004, now abandoned.
(60) Provisional application No. 60/491,718, filed on Aug. 1, 2003.

(51) Int. Cl. B05D 3/12

(52) U.S. Cl. 427/355

(57) ABSTRACT

A method for forming an extrusion coated paperboard including the steps of providing an uncoated paperboard, providing at least one extrusion device and at least one moisture application device on a single extrusion process line, extruding a material onto a first side of the paperboard with the extrusion device and applying a moisture composition onto a second side of the paperboard, opposite of the first side, with the moisture application device such that an equilibrium moisture content of the extrusion coated paperboard is about 6 to about 15 percent based on total extrusion coated paperboard weight.

This application is a divisional application of U.S. Ser. No. 10/899,650 filed on Jul. 27, 2004, pending, which claims priority from U.S. Provisional Ser. No. 60/491,718 filed on Aug. 1, 2003, expired, the entire contents of which are incorporated herein by reference.

### BACKGROUND

The present application relates to methods for increasing moisture content in an extrusion coated paperboard.

Conventional methods for extrusion coating paperboard are well known. Conventional extrusion coated paperboards have been used to form a variety of packages. Generally, a paperboard is coated with one or more coatings of a polymer material to enhance barrier or aesthetic properties of the paperboard. The extrusion process typically involves the application of a molten polymer material to a moving web of paperboard using a conventional extrusion coater system. The extruded polymer is immediately cooled after application and the extrusion coated paperboard is rolled for shipment. At a converter, the paperboard is unwound, printed, and cut into container blanks. The container blanks are then formed into packages using known conventional techniques.

A conventional package forming technique involves thermoforming the container blank into the container shape. This technique involves applying heat and mechanical force concurrently to the container blank in a container forming die. Exemplary container thermoforming equipment is commercially available from Gralex Corporation of Lewis Center, Ohio. For proper container thermoforming with extrusion coated paperboard, the container blank must have a minimum moisture content. This is even more critical for a solid paperboard container blank as compared to a corrugated container blank. Corrugated container blanks have some inherent deformability due to their fluted layers. Proper moisture content in a solid paperboard container blank is critical to prevent catastrophic failure, such as tearing, during thermoforming. Without being limited to any particular theory, the applicants believe that the increased moisture content is necessary to ensure sufficient elasticity in the container blank during thermoforming. The elevated moisture content counter balances the various “moisture drying effects” that the paperboard substrate is subject to. For example, the paperboard is typically treated during the extrusion process to improve polymer adhesion. This “flame treatment,” along with the application of a hot, molten polymer, causes the paperboard to lose moisture. The extruded paperboard also loses moisture during shipping, handling, storage, and printing. During the thermoforming process, the blank's moisture content is further reduced when heat is transferred to the container blank. If the moisture content of the extrusion coated paperboard container blank is too low prior to the thermoforming process, defective formation may occur.

Conventional techniques for increasing the moisture content of the container blank involved the additional step of moistening a surface of the paperboard after the extrusion process and prior to printing and die cutting.

Exemplary moistening equipment includes an ITM-HD moisture application device manufactured by Peerless Machine and Tool Co. of Marion, Ind., and a Dahlgren-type system manufactured by Coating & Moisturizing Systems, Inc. of Gainesville, Ga. Typically, a container manufacturer or converter, such as Pactiv Corporation, purchases an extrusion coated paperboard from a manufacturer, such as International Paper Corporation or Blue Ridge Corporation. The converter then moistens the paperboard at his converting site using the moisture application device. The paperboard is then either printed and die cut with the printed blanks left to reach moisture equilibrium, or the moistened roll is left until moisture equilibrium is reached prior to printing and die cutting. To reach moisture equilibrium, the moisture that was applied to the surface of the paperboard must be absorbed throughout the entire paperboard until constant moisture content is reached. This process generally takes up to 24 hours. Whether printing and die cutting are done before or after the equilibrium period, container thermoforming cannot be performed until paperboard moisture equilibrium is reached. This moistening step increases the converter's production cost in at least two ways. First, each converter must have suitable moistening equipment at his converting site. Second, the moistening step extends his production or converting time due to the time required for moisture equilibrium. Accordingly, there is a need for a method of increasing the moisture content of extrusion coated paperboard immediately after the extrusion process, thus eliminating the need for converters to increase the paperboard moisture content during their converting process.

### SUMMARY

In one aspect, an extrusion coated paperboard is provided and includes a paperboard, an extruded material adhered to a first side of said paperboard and a moisture composition applied in-line during the extrusion process to a second side, opposite of said first side, of said paperboard such that a moisture content of said extrusion coated paperboard has an equilibrium moisture content range of about 6 to about 15 percent by weight based on total extrusion coated paperboard weight.

In another aspect, a method for forming an extrusion coated paperboard is provided and includes the steps of providing an uncoated paperboard, providing at least one extrusion device, providing at least one moisture application device, extruding a material onto a first side of said paperboard with said extrusion device and applying a moisture composition onto a second side of said paperboard, opposite of said first side, with said moisture application device such that an equilibrium moisture content of said extrusion coated paperboard is about 6 to about 15 percent total extrusion coated paperboard weight.

In another aspect, a method for forming an extrusion coated paperboard is provided and includes the steps of providing an uncoated paperboard, providing at least one extrusion device, providing at least one moisture application device, wherein the moisture application device and the extrusion device are on a single extrusion process line, extruding a material onto a first side of the paperboard with the extrusion device and applying a moisture composition onto a second side of the paperboard, opposite of the first side, with the moisture application device such that an equilibrium moisture content of the extrusion coated paperboard is about 6 to about 15 percent based on total extrusion coated paperboard weight.

In another aspect, a method is provided for applying a polymeric extrusion and a moisture composition in a single extrusion process line. Following the extrusion process and moisture application, the paperboard may be wound in a roll and shipped.

Other aspects will become apparent from the following detailed description, the accompanying drawings and the appended claims.

### BRIEF DESCRIPTION OF THE DRAWINGS

FIG. 1 is a schematic view of an exemplary system according to one aspect of the disclosed system and method;

FIG. 2 is a schematic view of a moisture application device of the system of FIG. 1;

FIG. 3 is a front elevational view, shown in cross-section, of an extrusion coated paperboard;

FIG. 4 is a front elevational view, shown in cross-section, of the paperboard of FIG. 3 after a moisture composition has been applied thereto; and

FIG. 5 is a front elevational view, shown in cross-section, of the paperboard of FIG. 4 after moisture equilibrium has been reached.

### DETAILED DESCRIPTION

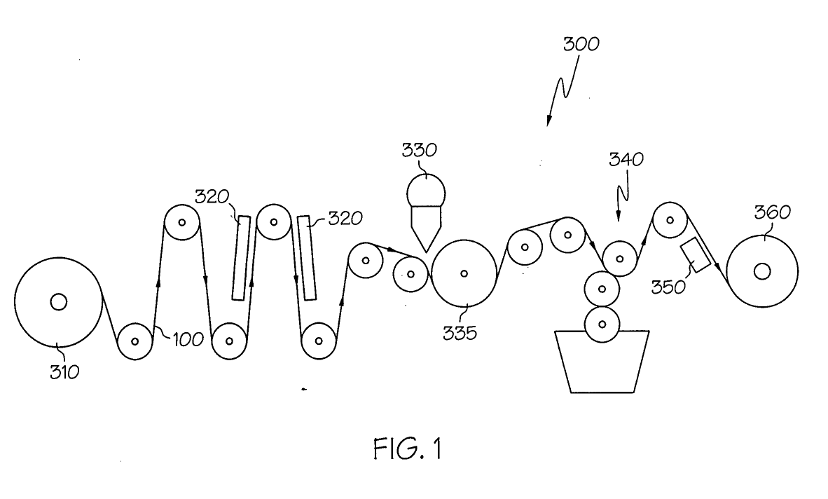

FIG. 1 illustrates a schematic view of an exemplary extrusion system 300 according to one aspect of the disclosed system and method. It should be understood that the present application is applicable to a wide range of extrusion coating systems 300. FIG. 1 is only intended to illustrate an exemplary system and does not limit the scope of the present application.

The system 300 is illustrated with a paperboard 100 formed as a web and placed on the system 300 as a roll 310. The present invention is applicable to a wide range of conventional paper or paperboard materials that provided sufficient strength for their intended end use. An exemplary paperboard 100 is a non-claycoated solid bleached sulphate (SBS) paperboard material. The paperboard 100 could be bleached or unbleached as desired. A bleached surface is desirable when the paperboard 100 will be used in a cooking application. Typical basis weights for the paperboard 100 are in the range of about 70 pounds per 3,000 square feet to about 350 pounds per 3,000 square feet. Typically, the paperboard 100 has a thickness or caliper range of about 0.007 inches to about 0.035 inches. The present invention covers the full range of paper or paperboard substrates, as applied to the packaging field and other suitable applications.

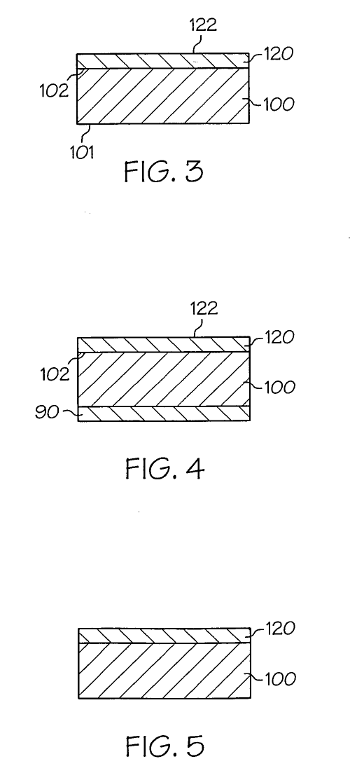

As shown in FIGS. 1 and 3, a roll 310 is placed into an extrusion system 300 using conventional techniques and unwound. A first surface 102 of the paperboard 100 is optionally heated with one or more flame apparatus 320 to improve the bond between the paperboard 100 and an extruded material 120 applied to the surface 102 of the paperboard 100. The extruded material 120 is extruded onto the surface 102 of the paperboard 100 using conventional extrusion equipment 330. The extruded material 120 is typically selected such that a contact surface 122 may be in contact with an article (not shown) placed inside a container (not shown) formed from the paperboard 100. One common extruded material 120 is a material suitable for food contact.

FIG. 3 illustrates a paperboard 100 with the extruded material 120 secured to the paperboard surface 102. The extruded material 120 may be any suitable extrusion material 120. Exemplary extruded materials 120 include polyethylene terephthalate (PET), polymethylpentene (PMP), polyethylene (PE), polybutylterephthalate (PBT), polypropylene (PP), Nylon (PA) and other suitable materials. Suitable coat weight ranges for PET include a coat weight range of about 8 pounds per 3,000 square feet to about 30 pounds per 3,000 square feet with an exemplary range of about 15 pounds per 3,000 square feet or greater. Suitable coat weight ranges for PMP include a coat weight range of about 5 pounds per 3,000 square feet to about 15 pounds per 3,000 square feet with an exemplary range of about 8 pounds per 3,000 square feet or greater. Suitable coat weight ranges for PE include a coat weight range of about 5 pounds per 3,000 square feet to about 30 pounds per 3,000 square feet with an exemplary range of about 8 pounds per 3,000 square feet or greater. Suitable coat weight ranges for PA include a coat weight range of about 5 pounds per 3,000 square feet to about 30 pounds per 3,000 square feet. If PA is used as a layer within a composite structure that may include any other suitable extruded materials, an exemplary coat weight range is about 8 to about 12 pounds per 3,000 square feet. Suitable coat weight ranges for PP include a coat weight range of about 5 pounds per 3,000 square feet to about 30 pounds per 3,000 square feet, with an exemplary range of about 8 pounds per 3,000 square feet or greater. Suitable coat weight ranges for PBT include a coat weight range of about 5 pounds per 3,000 square feet to about 30 pounds per 3,000 square feet with an exemplary range of about 15 pounds per 3,000 square feet or greater. It is to be understood that multiple extruded materials 120 could be applied during the extrusion process in one or more layers, using one or more extrusion apparatus 330. It is to be further understood that one or more pigments, additives or other compositions could be added or blended with the extruded material 120. For example, a pigment could be added to alter the color, opacity or aesthetic properties of the extruded material 120 or paperboard 100.

In containers used for cooking applications made from the paperboard, the extruded material 120 should ideally be mass stable or have a melting point of about 450 degrees Fahrenheit or higher and have chloroform-soluble extractives not exceeding 0.5 milligrams per square inch of the food contact surface.

Returning to FIG. 1, a cooling roll 335, commonly referred to as a chill roll, contacts the extruded material 120 immediately after it is applied to the paperboard 100 by the extrusion apparatus 330. The chill roll 335 helps to form a strong bond between the extruded material 120 and the paperboard 100.

As illustrated in FIGS. 1, 2 and 4, a moisture composition 90 is applied to the underside 101 of the paperboard 100 by a moisture application device 340. A typical moisture composition 90 includes water. It is to be understood that one or more additives or moisture retention aids may be mixed in with the moisture composition 90. Also, numerous compositions and concentrations of moisture composition 90 are within the scope of the invention.

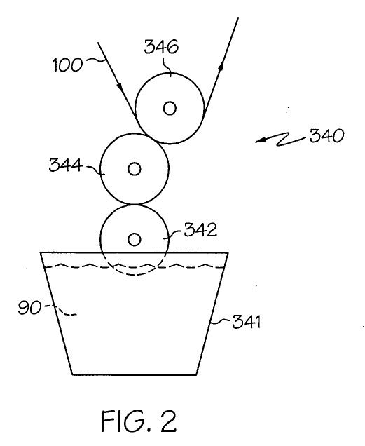

FIG. 2 schematically illustrates, in detail, an exemplary moisture application device 340. The device of FIG. 2 is commonly referred to as a Dahlgren type moisture application device 340. One conventional device 340 is manufactured by Coating and Moisturizing Systems of Gainsville, Ga. It is to be understood that the invention covers a wide range of moisture application devices 340 or moisture application means, such as spraying systems and other roll applicator systems. The key feature is that the moisture device 340 be operated in a manner to increase the moisture content of the paperboard 100 to a desired moisture level to improve converting properties of the paperboard. As illustrated in FIG. 2, the Dahlgren system has three main rolls: a metering roll 342, a transfer roll 344, and a backing roll 346. The metering roll 342 is in contact with the moisture composition 90. The moisture composition 90 is retained in a moisture container 341. In one system according to the present invention, the transfer roll 344 is chemically treated to create an attraction to the moisture 90. A thin film of moisture 90 is metered to the transfer roll 344 by controlling nip pressures and differential speed between the metering roll 342 and transfer roll 344. At high transfer roll 344 speeds in the reverse direction of the paperboard's 100 travel direction, the moisture 90 is impregnated into the paperboard 100. As shown in FIG. 1, an exemplary moisture sensor 350 is positioned downstream from the moisture application device 340 and can be used to monitor the moisture content of the paperboard 100. Although not shown, a moisture sensor 350 could also be placed upstream of the moisture application device 340. It is to be understood that system 300 could also include various controls (not shown) and other sensor devices (not shown), such as computers, software, electrical, pneumatic, or mechanical devices to communicate and control the system 300 and or the moisture application device 340.

It is to be understood that the moisture composition 90 should ideally be applied after the extruded material 120 has been secured to the paperboard 100. FIG. 5 depicts the paperboard 100 after the moisture composition 90 of FIG. 4 has been absorbed throughout the paperboard 100 and moisture equilibrium has been reached. Moreover, while only one moisture application device 340 has been illustrated in FIG. 1, it is to be understood that two or more (not shown) moisture devices 340 could be used with the system 300. Also, the location of the moisture device 340 could be varied. For example, one device 340 (not shown) could be placed upstream of the extrusion apparatus 330. Of course, if too much moisture is added upstream it may result in poor adhesion between the extruded material 120 and the paperboard 100. Likewise, two or more (not shown) moisture devices 340 could be placed downstream of the extrusion apparatus 330.

Returning to FIG. 1, the finished paperboard is typically wound into a roll 360 for shipment to a converter. It is to be understood that the paperboard could also be sheeted prior to shipment. Although not shown, it is also to be understood that the roll 360 is ideally placed in a moisture barrier package and shipped and handled within certain temperature and humidity ranges to increase the shelf life of the paperboard and to maintain the paperboard's moisture content. It is to be further understood that extrusion coated paperboard manufactured according to the invention could also be converted into container blanks (not shown). The container blanks could then be thermoformed into a vessel or container. However, the invention covers any use of extrusion coated paperboard produced according to the present invention.

Given the above detailed description, many other embodiments, features, modifications or improvements will become apparent to those skilled in the art. Such other embodiments, features, modifications and/or improvements are therefore considered to be a part of the present invention, the scope of which is to be determined by the following claims.

What is claimed is:

1. A method for forming an extrusion coated paperboard comprising the steps of:
providing an uncoated paperboard;
providing at least one extrusion device;
providing at least one moisture application device, wherein said moisture application device and said extrusion device are on a single extrusion process line;
extruding a material onto a first side of said paperboard with said extrusion device; and
applying a moisture composition onto a second side of said paperboard, opposite of said first side, with said moisture application device such that an equilibrium moisture content of said extrusion coated paperboard is about 6 to about 15 percent based on total extrusion coated paperboard weight.

2. The method of claim 1 wherein said moisture application device is a Dahlgren moisture application device.

3. The method of claim 1 wherein said moisture application device is a spraying type moisture application device.

4. The method of claim 1 wherein said extrusion coated paperboard is rolled up after said moisture composition is applied.

5. The method of claim 1 wherein said extrusion coated paperboard is sheeted after said moisture composition is applied.

6. The method of claim 1 wherein said extrusion coated paperboard is placed in a moisture barrier package.

7. The method of claim 1 wherein said extrusion coated paperboard has printed or graphic indicia on at least one of said first and second sides.

8. The method of claim 1 wherein said paperboard is flame treated prior to extruding said material to said paperboard.

9. The method of claim 1 wherein a moisture sensor measures the moisture content of said paperboard after said moisture application device.

10. The method of claim 1 wherein a moisture sensor measures the moisture content of said paperboard before said moisture application device.

11. The method of claim 1 wherein an automated control system monitors and adjusts at least one of said moisture applying and said extruding steps.

12. The method of claim 1 wherein said moisture composition includes at least one of a biological growth inhibitor and a water retention aid.

13. The method of claim 1 further comprising the step of positioning a cooling roll between said moisture application device and said extrusion device.
